(19) United States
(12) Patent Application Publication
(10) Pub. No.: US 2011/0143001 A1
(43) Pub. Date: Jun. 16, 2011

(54) DATE KERNEL PREPARATION

(75) Inventors: Shay Cohen, Herzliya (IL); Gili Haberman, Givataim (IL); Rom Kshuk, Herzeliya (IL); Limor Gendler, Shimshit (IL)

(73) Assignee: GREEN LIFE CAFÉ LTD., Herzeliya (IL)

(21) Appl. No.: 13/058,298

(22) PCT Filed: Aug. 11, 2009
(86) PCT No.: PCT/IL09/00780

§ 371 Date: Feb. 9, 2011

Related U.S. Application Data
(60) Provisional application No. 61/136,055, filed on Aug. 11, 2008.

(51) Int. Cl. A23L 2/52; A23F 5/44; A23L 2/38; A23L 2/58

(52) U.S. Cl. 426/250; 426/629; 426/595; 426/598

(57) ABSTRACT

Provided is a preparation including a roasted date kernel blend and at least one thickener, a beverage thereof, a process for the production thereof and a process for producing the beverage.

This is a National Phase Application filed under 35 U.S.C. 371 as a national stage of PCT/IL2009/000780, filed on Aug. 11, 2009, an application claiming the benefit under 35 USC 119(e) of U.S. Provisional Application No. 61/136,055, filed on Aug. 11, 2008, the content of each of which is hereby incorporated by reference in its entirety.

### FIELD OF THE INVENTION

This invention relates to the field of health preparations.

### BACKGROUND OF THE INVENTION

The Date Palm (Phoenix dactylifera) is a palm within the genus Phoenix, extensively cultivated in most of the warm climate areas for centuries. Almost each part of the date palm tree and fruit have been used for numerous purposes.

Whole dates consist approximately of 85% edible fruit flesh (tissue) and 15% kernels depending on fruit stage maturity and variety. Since the fruit's flesh is the most productive element of the date fruit, its kernels are usually considered waste and are thus generally removed.

The nutritional ingredients of the date kernel include water, proteins, amino acids (such as for example glutamic acid, aspartic acid, arginine, lysine, isoleucine and tryptophan), fatty acids (such as for example oleic acid, lauric acid, myristic acid, palmitic acid, and linoleic acid), dietary fibers (such as hemicellulose, cellulose, and lignin), fibers such as galactomannan (soluble fiber), glucose, fructose, phenolic compounds (such as for example 3,4-dihydroxyphenylacetic acid, hydroxytyrozole, protocatechaic acid, tyrozole, galic acid, capaic acid, cumaric acid, and oleorpheine), ash, heteroxylane, tanins, acetic acid, sterols (such as cholesterol, campsterol, stigmasterol, and beta-sitosterol), vitamin E and minerals (such as for example potassium, phosphate, magnesium, calcium, iron, and zinc).

Some of the nutritional ingredients of the date kernels are similar to the ones found in natural olive oil (for example the fatty acids, phenolic and sterol compounds). Thus, date kernels possess many health benefits due to e.g. their anti-oxidative properties, antiviral and antimicrobial properties, cholesterol lowering properties and additional disease prevention properties.

U.S. Pat. No. 237,273 describes the use of whole date fruits to prepare a date preparation.

WO97/01286 describes the use of dates for the preparation of a flavoring substance.

GB2321841 describes the use of date kernels for the preparation of a syrup.

DE3931504 describes a coffee-like date preparation.

### SUMMARY OF THE INVENTION

It is an object of the invention to provide a preparation which not only tastes similar to coffee but also has a texture similar to coffee, but which is not coffee.

The subject invention thus provides a preparation comprising a roasted date kernel blend and at least one thickener.

In a further aspect the invention provides a beverage comprising a preparation comprising a roasted date kernel blend and at least one thickener.

In another aspect the invention provides a process of producing a preparation comprising a roasted date kernel blend and at least one thickener, said process comprising the following steps (irrespective of their order):
(a) producing a batch of roasted date kernels comprising:
   (i) drying date kernels;
   (ii) roasting the dried date kernels or roasting crude date kernels;
   (iii) grinding the roasted date kernels.
(b) mixing at least two batches of roasted date kernels so obtained thereby producing a roasted date kernel blend;
(c) adding at least one thickener;
(d) optionally adding at least one food colorant; and
(e) optionally adding ground roasted coffee.

The invention further provides a process of producing a beverage comprising mixing a preparation obtained by a process of the invention with at least one liquid.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic overview of one embodiment of a process for the preparation of a roasted date kernel blend of the invention.

FIG. 2 is a schematic overview of one embodiment of a process for the production of a date kernel preparation of the invention.

FIG. 3 is a schematic overview of another embodiment of a process for the production of a date kernel preparation of the invention.

### DETAILED DESCRIPTION OF THE INVENTION

The present invention provides a preparation comprising a roasted date kernel blend and at least one thickener.

In the context of the present invention the term “date kernel” relates to the internal hard grain, seed, stone pip or pit of a date palm (Phoenix dactylifera) fruit. A date palm fruit may originate from any date palm cultivar or variety or species, such as, but not limited to Barhi, Dayri, Deglet Noor, Halawy, Hayany, Khadrawy, Khastawi, Maktoom, Medjool, Saidy, Sayer, Thoory, Zandi, Aabel, Ajwah, Al-Barakah, Amir Hajj, Abid Rahim, Barakawi, Bireir, Empress, Ftimi, Haleema, Iteeme, Kajur, Kenta, Khalasa, Manakbir, Migraf, Mgmaget Ayuob, Mishriq, Nabtat-seyf, Rodab, Sag'ai, Sekkeri, Sellaj, Tagyat, Tamej, Umeljwary, Umelkhashab or any mixture thereof.

In one embodiment, date kernels are entirely separated from the date fruit flesh either in the ripe stage of the fruit or in its immature stage, prior to their use in the preparation and process of the invention.

In another embodiment, date kernels are partially separated from the date fruit flesh either in the ripe stage of the fruit or in its immature stage, prior to their use in the preparation and process of the invention.

It should be understood that “partially” as used herein in the context of the separation of the date kernels from the date fruit flesh means that no more than 5% of fruit flesh remains within the date kernel raw material to be roasted.

In one embodiment a roasted date kernel blend is a mixture of at least two batches of roasted date kernels wherein at least one batch has a different degree of roasting and/or a different degree of grinding and/or is produced from a different date species or mixture of date species than the other batches in the roasted date kernel blend.

In another embodiment a roasted date kernel blend is a mixture of at least three batches of roasted date kernels wherein at least one batch has a different degree of roasting and/or a different degree of grinding and/or is produced from a different date species or mixture of date species than the other batches in the roasted date kernel blend.

In one embodiment a roasted date kernel blend is a mixture of at least four batches of roasted date kernels wherein at least one batch has a different degree of roasting and/or a different degree of grinding and/or is produced from a different date species or mixture of date species than the other batches in the roasted date kernel blend.

It should be noted that in the context of the present invention the “degree of roasting” is defined by a temperature or temperature range at which a batch of date kernels is heated and the time period such a batch is exposed to said temperature or temperature range, resulting in a specific taste and color of the roasted material. In one embodiment a batch of date kernels is roasted at a temperature of between about 150° C. to about 300° C. In another embodiment a batch of date kernels is roasted at a temperature of between about 180° C. to about 270° C. In yet other embodiments of the invention, a batch of date kernels is roasted at a temperature of 180° C., 190° C., 200° C., 210° C., 220° C., 230° C., 240° C., 250° C. or 260° C. It is envisaged that a batch of date kernels is roasted for the duration of about 2 to about 60 minutes. In a further embodiment a batch of date kernels is roasted for the duration of about 6 to about 40 minutes. In yet other embodiments of the invention, a batch of date kernels is roasted for 6, 10, 12, 14, 16, 20, 24, 28, 32, 34, 36 or 40 minutes.

It should be noted that in the context of the present invention the “degree of grinding” is defined by the particle size distribution of a batch of date kernels, hi one embodiment the average particle size of a batch of date kernels is between about 30 microns to about 2000 microns. In a further embodiment the average particle size of a batch of date kernels is between about 100 microns to about 700 microns. In another embodiment, the average particle size of a batch of date kernels is about 500 microns.

When batches having different degrees of roasting and/or grinding are mixed, the percentage of each batch within the resulting date blend may range from about 3% to about 80% by weight.

In one embodiment, when two batches are mixed, each batch may be present at 50%.

In another embodiment, one batch may represent 30%, and the other batch 70% of the roasted date blend.

In one embodiment, when mixing three batches, each batch may represent 33.3% of the roasted date blend. In another embodiment, one batch may represent 50%, another batch 40% and anther batch 10% of the roasted date blend.

In one embodiment, when mixing four batches, each batch may represent 25% of the roasted date blend. In another embodiment, one batch may represent 30%, another batch 50% and two other batches 10% of the roasted date blend.

The term “thickener” as used herein should be understood to encompass any substance which, when added to a liquid or a mixture of liquids, at any temperature, increases the viscosity of said liquid or mixture of liquids without substantially modifying other properties of the liquid or mixture of liquids, such as, but not limited to flavour, colour, smell, and overall appearance.

Non-limiting examples of envisaged thickeners are: modified starches such as, but not limited to, pregelatinized hydroxypropyl distarch phosphate of vegetable origin (e.g. potato) (Pregel VA70G), pregelatinized acetylated distarch phosphate of vegetable origin (e.g. potato) (Eliane BC160), and pregelatinized starch of vegetable origin (e.g. rice) (Remyline XS-DR-p); natural starches such as, but not limited to, native starch of vegetable origin (e.g. potato) (Granamyl P 13), and pregelatinized purified vegetable starch (e.g. potato); gums such as, but not limited to, Tara Gum, Acacia (Arabic) gum, Xanthan Gum and Guar gum; and fibers of vegetable origin such as, but not limited to, chicory (Inulin), sugar beet (Fibrex), orange, carrot, pea, and cellulose.

In one embodiment, the thickener is a native starch. In a further embodiment the thickener is granamyl P13. In another embodiment a preparation of the invention comprises from about 1 to about 15 w/w % of at least one thickener. In a further embodiment a preparation of the invention comprises about 5 w/w % of at least one thickener.

In yet a further embodiment a preparation of the invention comprises at least one food colorant.

The term “food colorant” as used herein should be understood to encompass any substance capable of altering the color of a preparation of the invention or any product produced from a preparation of the invention. Food colorant as used herein may originate from any natural, semi-natural or artificial source. Food colorants may be either in powder form or in liquid form.

Non-limiting examples of food colorants are caramel color, burnt sugar (either in a powder form or in a liquid form) and carob powder.

In one embodiment, the at least one colorant is burnt sugar powder. In another embodiment, the at least one food colorant is liquid burn sugar. In yet another embodiment, the at least one colorant is carob powder.

In one embodiment a preparation of the invention comprises from about 0.05 to about 8 w/w % of burnt sugar powder. In another embodiment a preparation of the invention comprises about 4 w/w % of burnt sugar powder.

In one embodiment a preparation of the invention comprises from about 0.01 to about 8 w/w % of liquid burnt sugar.

In yet another embodiment a preparation of the invention comprises from about 0.05 to about 15 w/w % of carob powder.

In another embodiment a preparation of the invention further comprises ground roasted coffee. In a further embodiment a preparation of the invention comprises from about 0.5 to about 30 w/w % of ground roasted coffee. In yet a further embodiment a preparation of the invention comprises about 2 w/w % of ground roasted coffee.

The term “coffee” as used herein should be understood to encompass any type of regular coffee and decaffeinated coffee. Non-limiting examples of coffee types are arabica, robusta and any mixture thereof.

In another one of its aspects the invention provides a beverage comprising a preparation of the invention.

In the context of the present invention the term “beverage” should be understood to encompass any drinkable substance prepared using a preparation of the invention with a predetermined amount of at least one liquid, such as for example water, milk, alcohol, fruit juice or any mixture thereof. Such a liquid may be added either hot (for example in a temperature range of between about 26° C. to about 100° C.) or cold (for example in a temperature range of between about 2° C. to about 25° C.).

In another one of its aspects, the invention provides a nutritional composition, a food product, a nutraceutical composition, or a functional food comprising a preparation of the invention.

A nutritional composition or functional food as used herein can be any nutritional composition including, but not limited to infant formula and food, dairy product, icecream, biscuit, soy product, pastry and bread product, sauce, soup, frozen food, confectionery, margarine, spread, filling, cereal, instant product, bar, snack, candy and chocolate product.

A nutraceutical composition as used herein can be any nutraceutical, which can be any substance that may be considered a food or part of a food and provides medical or health benefits, including the prevention and treatment of disease. Such nutraceutical compositions include, but are not limited to, a food additive, a food supplement, a dietary supplement, herbal products, and processed foods such as cereals, soups and beverages and stimulant functional food and pharmafood.

In another aspect of the invention there is provided a process of producing a preparation of the invention, said process comprises the steps of:
(a) producing a batch of roasted date kernels comprising:
   (i) drying date kernels;
   (ii) roasting the dried date kernels or roasting crude date kernels;
   (iii) grinding the roasted date kernels.
(b) mixing at least two batches of roasted date kernels so obtained, thereby producing a roasted date kernel blend;
(c) adding a thickener;
(d) optionally adding a food colorant; and
(e) optionally adding ground roasted coffee.

It should be understood that the order of the steps in the process of the invention is not fixed. In other words, it is also an embodiment of the invention that the at least one thickener is initially mixed with an optional food colorant and optional roasted coffee and that this mixture is thereafter mixed with a roasted date blend.

The term “drying” or any lingual derivatives thereof should be understood to encompass a process for the removal of moisture or any other aqueous and/or non-aqueous liquids or vapors from the internal and/or external part of a date kernel. The drying of the date kernels may be performed at a temperature of between about 20° C. to about 110° C. Non-limiting examples of drying processes which may be used in the process of the invention include: air drying, sun drying, fluidized bed drying, oven drying, conveyor drying, microwave drying and so forth. In one embodiment, the drying is performed by air drying.

In one embodiment drying is carried out until water activity is less than 0.4 aw.

It should be noted that date kernels used in the process of the invention may be either dried as mentioned above or crude, i.e. not dried, as separated from the date palm fruit flesh.

The term “roasting” or any of its lingual derivatives should be understood to encompass a process in which date kernels are heated to a certain temperature or temperature range for a fixed period of time. The heat may be created by any kind of flame or oven. The heat source may be supplied by any kind of fuel such as for example natural gas, biogas, biofuel, liquefied petroleum gas (LPG), wood, electric power, or radiation (such as for example infra red radiation, microwave radiation and so forth).

In one embodiment the roasting may be performed in a horizontal or vertical rotating drum or bowl (either with or without blades) that may be heated (directly or indirectly) from any direction while the date kernels are tumbled inside, hi another embodiment said drum or bowl is static (i.e. not rotating). When using such drums or bowls, roasting may be carried out either batch by batch or in a continuous mode.

In another embodiment the roasting may be performed in a fluidized bed process. In yet another embodiment the roasting may be performed in a pressure roasting process. In yet another embodiment, the roasting may be performed on a pan roaster.

In a further embodiment of the present invention, roasting step (ii) is carried out at a temperature of between about 150° C. to about 300° C. In yet another embodiment roasting step (ii) is carried out at a temperature of between about 180° C. to about 270° C.

In another embodiment of the invention, roasting step (ii) is carried for 2 to 60 minutes. In yet a further embodiment roasting step (ii) is carried for 6-40 minutes.

The term “grinding” or any lingual derivatives thereof should be understood to encompass a process for producing a powder comprising particles of roasted date kernel batch. The grinding can be carried out with any grinder such as, but not limited to a disc mill (such as Mazzer super jolly mini grinder), stone mill, multi roll mill (such as Gump mill), cutting blades mill, hammer mill, impact mill and so forth.

In another embodiment grinding step (iii) is performed to obtain a powder having a average particle size of between about 30 microns to about 2000 microns. In a further embodiment grinding step (iii) is performed to obtain an average particle size of between about 100 microns to about 700 microns. In yet a further embodiment grinding step (iii) is performed to obtain an average particle size of about 500 microns.

In another aspect the invention provides a process of producing a beverage comprising mixing a date kernel preparation obtained by a process of the invention with at least one liquid. In one embodiment the at least one liquid comprises water. In another embodiment the at least one liquid further comprises milk. Said mixing of a preparation of the invention with at least one liquid may be preformed manually or with the aid of a beverage making machine.

In one embodiment of the invention, a beverage comprising a preparation of the invention is prepared using a coffee making machine such as for example an espresso/cappuccino machine (wherein a preparation of the invention is added into a coffee machine either as a powder or enclosed in a capsule or pod), a coffee press machine, a coffee brewing machine, a percolator and so forth.

In one embodiment a preparation of the invention may further comprise at least one flavoring agent.

The term “flavoring agent” as used herein should be understood to encompass any substance capable of altering the flavor of a preparation of the invention, without altering any other properties of the preparation. The flavoring agent may originate from a natural, semi-natural or artificial source. Non-limiting examples of flavors are coffee espresso ultraseal Q-143324 (Givaudan), coffee flavor L-139329 (Givaudan), coffee flavouring W2041-5 NIO (Ungerer), coffee flavouring 3740-1N1 (Ungere), coffee flavouring W33239-2N5 (Ungere), Coffee Flavor 3341950 (Frutarom), Coffee flavor 3324000 (Frutarom), bitterol 770/72 (Frutarom), coffee flavouring V5528-1N10 (Ungere), coffee flavouring V3458-1N1 (Ungere), Natural coffee flavors (Bacto flavours), coffee extract WS (Plant lipids), coffee flavouring pw4043-INI (Ungerer), coffee flavouring p3239-IN5 (Ungere) and coffee flavour DK909-015-6 (Givaudan).

The preparation of the invention and beverages containing such preparation are useful for the treatment and prevention of many diseases and disorders such as, but not limited to elevated blood pressure, ulcer, infection (viral, bacterial or other), elevated cholesterol, obesity, constipation, cancer, immune system disorders, cardiovascular diseases, ageing, metabolism disorders, and so forth.

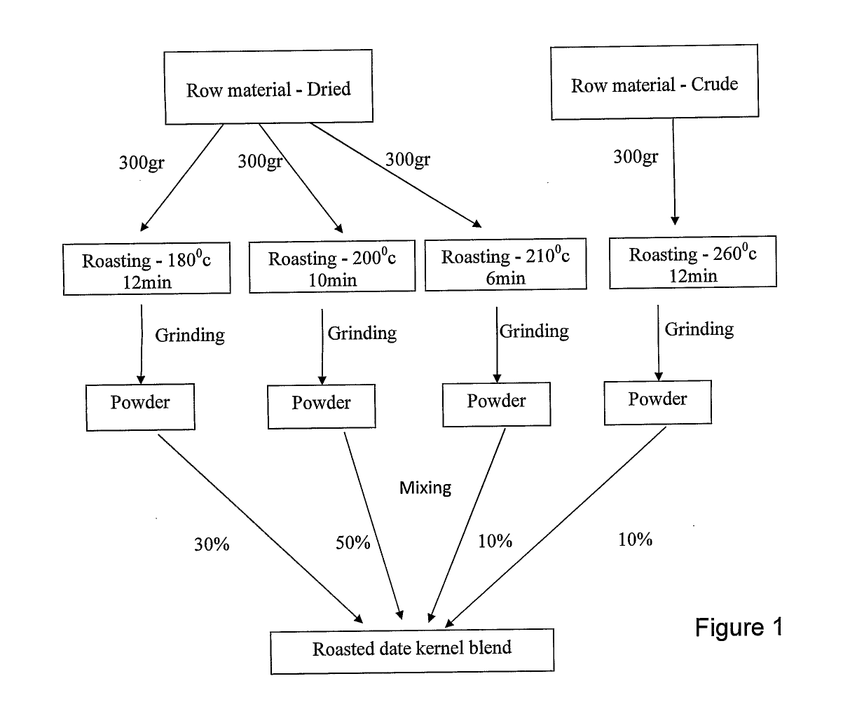

FIG. 1 is a schematic overview of one embodiment of a process for a preparation of a roasted date kernel blend of the invention. According to this embodiment four batches of 300 g of date kernels each (three pre-dried date kernel batches and one crude batch) are each roasted at different temperatures (180° C., 200° C., 210° C. and 260° C. respectively) and different times (for a duration of 12, 10, 6 and 12 minutes respectively). Each batch is then grinded to a powder having an average particle size of 500 microns. Each grinded batch is mixed in a predetermined ratio (30%, 50%, 10% and 10% respectively) to provide the roasted date kernel blend.

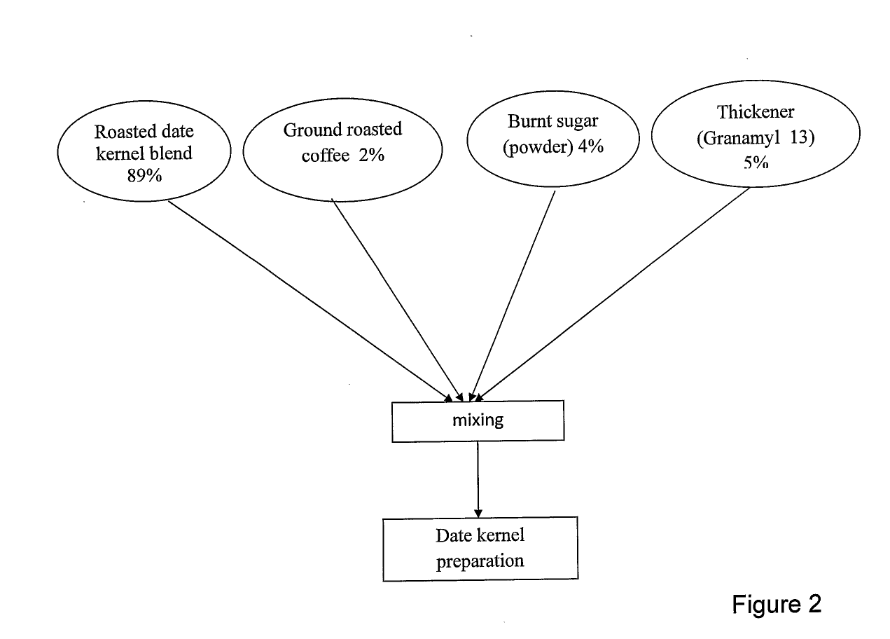

FIG. 2 is a schematic overview of one embodiment of a process for the production of a date kernel preparation of the invention. According to this embodiment a roasted date kernel blend (89%) prepared according to the invention (e.g. in FIG. 1) is mixed with a thickener (Granamyl P13) (5%), a food coloring agent (burnt sugar powder) (4%) and ground roasted coffee (2%), thereby providing a date kernel preparation, which, upon addition of at least one liquid substance, turns into a drinkable beverage.

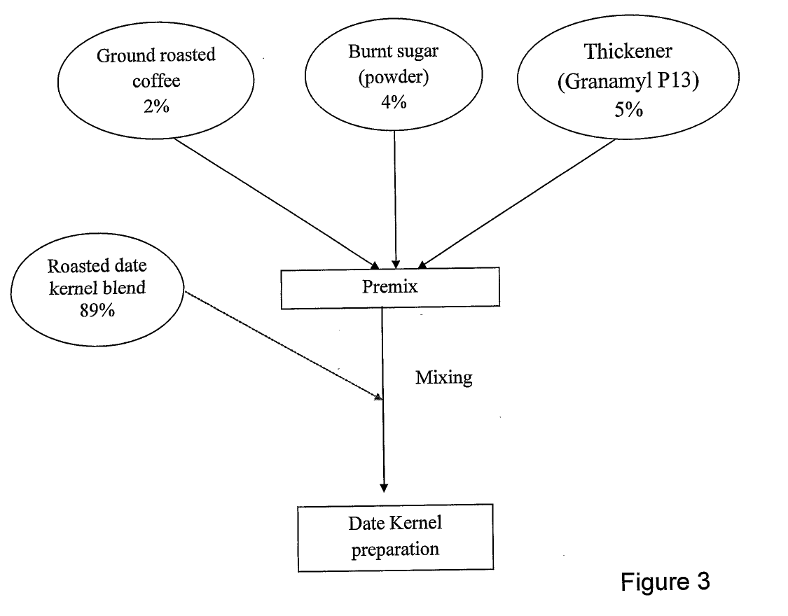

FIG. 3 is a schematic overview of another embodiment of a process for the production of a date kernel preparation of the invention. According to this embodiment the thickener (Granamyl P13) (5%), the coloring agent (burnt sugar powder) (4%) and the ground roasted coffee (2%) are initially premixed. This pre-mixture is then added to a roasted date kernel blend (89%) prepared according to the invention (e.g. in FIG. 1) and mixed to obtain a date kernel preparation, which upon addition of at least one liquid substance, turns into a drinkable beverage.

The invention is further described in the following example, which is not in any way intended to limit the scope of the inventions as claimed.

### EXAMPLES

### Example 1

### Preparing a Beverage with a Preparation of the Invention

The present example relates to a process for the preparation of a coffee (cappuccino)-like beverage using an espresso machine (Rancilio silvia).

14 gr of a preparation of the invention are poured into a filter basket suitable for the type and model of the espresso/cappuccino making machine. The powder is pressed using a tamper to be equivalent to 15 kg. Basket filter is tightly connected to the machine. Approximately 40 ml of liquid are passed through filter basket holding the preparation of the invention to produce a similar volume of hot beverage. About 130 ml of steamed milk (60-70° C.) is added to produce the cappuccino-like drink. Additional sweetener may be added to drink.

1-35. (canceled)

36. A preparation comprising a roasted date kernel blend and at least one thickener.

37. The preparation according to claim 36, wherein the roasted date kernel blend is a mixture of at least two batches of roasted date kernels wherein at least one batch has a different degree of roasting and/or a different degree of grinding and/or is produced from a different date species or mixture of date species than the other batches in the roasted date kernel blend.

38. The preparation according to claim 36, wherein the thickener is a native starch.

39. The preparation according to claim 36, wherein the preparation comprises about 1 to 15 wt % thickener of the preparation.

40. The preparation according to claim 36, further comprising a food colorant.

41. The preparation according to claim 36, further comprising ground roasted coffee.

42. A beverage comprising the preparation according to claim 36.

43. A process of producing a preparation according to claim 36, comprising:
producing a batch of roasted date kernel comprising:
drying date kernels or crude date kernels;
roasting the dried date kernels or roasting crude date kernels to produce roasted date kernels;
grinding the roasted date kernels;
mixing at least two batches of roasted date kernels to produce a roasted date kernel blend;
adding at least one thickener to the roasted date kernel blend;
optionally adding at least one food colorant; and
optionally adding ground roasted coffee.

44. The process according to claim 43, wherein drying is carried out until water activity is less than 0.4 aw.

45. The process according to claim 43, wherein roasting is carried out at a temperature of from about 150° C. to about 300° C.

46. The process according to claim 43, wherein roasting is carried for 2 to 60 minutes.

47. The process according to claim 43, wherein grinding is performed until a powder with an average particle size of between about 30 microns to about 2000 microns is obtained.

48. The process according to claim 43, wherein the thickener is added in an amount of from 1 to 15 wt % of the preparation.

49. The process according to claim 43, further comprising adding of ground roasted coffee, in an amount of from about 0.5 to 30 wt % of the preparation.

50. A process of producing a beverage comprising mixing a preparation obtained by the process according to claim 43, with at least one liquid.
